(19) United States
(12) Patent Application Publication
(10) Pub. No.: US 2025/0383050 A1
(43) Pub. Date: Dec. 18, 2025

(54) CRYOGENIC DEWAR ANNULAR SPACE SENSOR CABLE

(71) Applicant: MVE Biological Solutions US, LLC, Brentwood, TN (US)

(72) Inventors: Jeffry Dresow, New Prague, MN (US); Douglas S. Wilcox, Cumming, GA (US); Hanlin Feng, Carver, MN (US); Henry Gibson, Saint Peter, MN (US)

(73) Assignee: MVE Biological Solutions US, LLC, Brentwood, TN (US)

(21) Appl. No.: 19/222,841

(22) Filed: May 29, 2025

Related U.S. Application Data
(60) Provisional application No. 63/660,368, filed on Jun. 14, 2024.

(51) Int. Cl. F17C 13/02; F17C 3/08

(52) U.S. Cl. CPC F17C 13/026; F17C 3/08; F17C 2203/0391; F17C 2203/0629; F17C 2205/0323; F17C 2221/014; F17C 2223/0161; F17C 2250/0439; F17C 2250/0491

(57) ABSTRACT

A dewar can comprise a cable routing configuration for a temperature sensor. The cable routing configuration can be disposed through a radial flange of a neck tube assembly or a fitting coupled to an outer vessel of the dewar. The cable routing configuration can be further disposed through a second radial flange into a cavity defined by an inner vessel or through a second fitting coupled to an inner vessel. The temperature sensor can be coupled to an external surface of the inner vessel or an inner surface of the inner vessel.

### CROSS REFERENCE TO RELATED APPLICATION

This application is based upon and claims the benefit of and priority to U.S. Provisional Patent Application No. 63/660,368 entitled “CRYOGENIC DEWAR ANNULAR SPACE SENSOR CABLE,” filed on Jun. 14, 2024, the entire content of which is incorporated by reference herein.

### FIELD

The present disclosure generally relates to cryogenic fluid containers, and more particularly to a dewar featuring a neck tube with a cable coupled thereto.

### BACKGROUND

A cryogenic dewar is a container used for storage and transport of cryogenic materials at very low temperatures (e.g., liquid nitrogen boils at 77K or —196C at normal pressure). They are constructed with minimal thermal connections, including an evacuated space, between an outer vessel and inner vessel that contains the cryogenic materials (often liquid nitrogen, also called LN2, and some valuable items or matter that must be kept cold by the LN2 as it evaporates from the minor heat leak into the inner vessel from the outside world). The space between the vessels is evacuated to eliminate convective heat transport and insulated to reduce conductive and radiative heat transfer.

The biological materials stored in a cryogenic dewar can be either human or animal-based, and in some cases can be pharmaceuticals or other materials requiring cryogenic temperatures. The physics behind the standard cryogenic dewar design defines the neck tube which connects the outer vessel to the inner vessel at the top of the dewar as the highest heat inleak to the cryogen (refrigerant). When the cryogenic dewar is in the upright position, the dewar reaches thermal equilibrium and operates optimally.

The neck tube of a cryogenic dewar can be a vacuum-tight, low-heat conductance tube that attaches the outer top vessel of the dewar to the inner top vessel of the dewar. The neck tube can be the only attachment between the dewar outer vessel top and inner vessel top. The neck tube of the cryogenic dewar is typically designed and configured to minimize conductive heat leak into the dewar. The neck tube also facilitates access to the biological or other materials stored in the cryogenic dewar. The cryogenic dewar can also include a low-heat-conductance neck cork, which fits into the inside of the neck tube to reduce convective heat leak into the dewar. This neck cork may also be removed from the tank neck tube to allow access to the dewar contents (i.e., payload) through the neck tube.

The holding time of the dewar is an important parameter, and many users of the dewar desire to know the temperature of the biological or other materials in either real-time or historical. Furthermore, during transport of a dewar, the dewar may be exposed to an orientation other than upright, with any out-of-position orientation leading to a reduced holding time for the dewar, potentially compromising the temperature-sensitive materials inside the dewar. Accordingly, there are a number of devices commercially available in the market to monitor the cryogenic dewar storage temperature, along with other characteristics. The majority of these temperature monitoring devices route an electrical cable (e.g., a sensor) to connect the monitoring product to the inside of the dewar below the neck tube. While the electrical cables of these temperature monitoring devices allow temperature monitoring, they also add significant heat leak into the dewar, reducing the holding time of the dewar at cryogenic temperatures. Some of these electrical cables can reduce the dewar holding time by greater than 50%, depending upon the specific electrical cable design and the performance characteristics of the specific cryogenic dewar. Accordingly, improved systems, devices, and methods for facilitating temperature monitoring of a cryogenic dewar is desirable.

### SUMMARY

Disclosed herein is an improved cable routing configuration for a cryogenic dewar. The cable routing configuration includes a sensor cable routed along a radially outer surface of a neck tube of the cryogenic dewar. In various embodiments, the cable can be routed through a radial flange of a neck tube assembly or a fitting coupled to a vessel of the dewar. In various embodiments, a temperature sensor coupled to the cable can be coupled to an outer surface of an inner vessel of the dewar or an inner surface of the inner vessel of the dewar. In various embodiments, if the temperature sensor is coupled to the inner surface of the inner vessel, the cable can further be routed through a second radial flange of the neck tube assembly or a second fitting.

A neck tube assembly for a cryogenic dewar is disclosed herein. In various embodiments, the neck tube assembly includes a neck tube extending from a first longitudinal end to a second longitudinal end, the neck tube defining a central longitudinal axis, the neck tube having an attachment end defining a radial recess between a first radial flange and a second radial flange, the first radial flange disposed at the first longitudinal end, the first radial flange including a first aperture disposed axially through the first radial flange to the radial recess; and a cable extending through the first aperture into the radial recess.

In various embodiments, the neck tube includes an elongated tubular element extending from the attachment end to the second longitudinal end. In various embodiments, the neck tube assembly further includes a plurality of perforations, each perforation in the plurality of perforations extending radially through the elongated tubular element.

In various embodiments, the cable spirals along a radially outer surface defined by the radial recess from the first radial flange to the second radial flange. In various embodiments, the cable spirals to impede direct heat leakage such as may occur along a cable running in a straight line from the first radial flange to the second radial flange.

In various embodiments, the neck tube assembly further includes a sealant disposed in the first aperture.

In various embodiments, the second radial flange includes a second aperture extending axially from the radial recess towards the second longitudinal end.

In various embodiments, the cable extends through the second aperture. In various embodiments, a first sealant is disposed in the first aperture and a second sealant is disposed in the second aperture.

In various embodiments, the cable is bonded to a radially outer surface defined by the radial recess.

In various embodiments, a diameter of the cable is less than 0.20 inches (0.51 cm).

In various embodiments, the cable includes a positive wire and a negative wire of a thermocouple disposed therein. In various embodiments, the cable includes a first wire and a second wire of a resistance temperature detector (RTD) disposed therein.

In various embodiments, the neck tube assembly further includes a second cable, wherein the cable is a positive wire of a thermocouple, and wherein the second cable is a negative wire of the thermocouple.

A dewar is disclosed herein. In various embodiments, the dewar includes an outer vessel; an inner vessel disposed within the outer vessel; a neck tube coupled to the outer vessel and extending into a cavity defined by the inner vessel, the neck tube including a first radial flange extending radially outward from a tubular element, the first radial flange including an aperture extending axially therethrough; and a cable disposed through the aperture of the neck tube and extending to a measurement junction, the measurement junction coupled to the inner vessel.

In various embodiments, the measurement junction is coupled to an outer surface of the inner vessel.

In various embodiments, the neck tube further includes a second radial flange spaced apart longitudinally from the first radial flange, the second radial flange includes a second aperture extending axially therethrough, and the cable extends through the second aperture into the cavity defined by the inner vessel. In various embodiments, the cable spirals around the tubular element disposed between the first radial flange and the second radial flange. In various embodiments, the measurement junction is disposed within the inner vessel.

In various embodiments, the cable includes a positive wire and a negative wire of a thermocouple disposed therein.

In various embodiments, the dewar further includes a second cable, wherein the cable is a positive wire of a thermocouple, and wherein the second cable is a negative wire of the thermocouple.

A dewar is disclosed herein. In various embodiments, the dewar includes an outer vessel; an inner vessel disposed within the outer vessel; a neck tube coupled to the outer vessel and extending into a cavity defined by the inner vessel; a fitting coupled to the outer vessel, the fitting including a first aperture disposed through a first flange of the fitting; and a cable disposed through the first aperture, the cable extending to a measurement junction coupled to the inner vessel.

In various embodiments, the fitting is joined to the outer vessel via brazing or welding.

In various embodiments, the dewar further includes a second fitting coupled to the inner vessel, wherein the second fitting includes a second aperture disposed through a second flange, and the cable extends through the second flange of the second fitting to the measurement junction. In various embodiments, the measurement junction is coupled to an internal surface of the inner vessel.

In various embodiments, the fitting includes a main body coupled to the outer vessel, and the cable is disposed through the first aperture and around a tubular element of the neck tube. In various embodiments, the cable spirals around the tubular element. In various embodiments, the cable spirals around the inner vessel.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1A illustrates a cross-sectional view of a dewar, in accordance with various embodiments.

FIG. 1B illustrates a top-down view of a dewar, in accordance with various embodiments.

FIG. 2A illustrates a side view of a neck tube assembly, in accordance with various embodiments.

FIG. 2B illustrates a side view of a portion of a neck tube assembly, in accordance with various embodiments.

FIG. 2C illustrates a cross-sectional view of a portion of a neck tube assembly, in accordance with various embodiments.

FIG. 3A illustrates a temperature monitoring system for a dewar, in accordance with various embodiments.

FIG. 3B illustrates a temperature monitoring system for a dewar, in accordance with various embodiments.

FIG. 3C illustrates a temperature monitoring system for a dewar, in accordance with various embodiments.

FIG. 4A illustrates a cable routing configuration for a dewar, in accordance with various embodiments.

FIG. 4B illustrates a cable routing configuration for a dewar, in accordance with various embodiments.

FIG. 5A illustrates a cable routing configuration for a dewar, in accordance with various embodiments.

FIG. 5B illustrates a cable routing configuration for a dewar, in accordance with various embodiments.

FIG. 6A illustrates a portion of a temperature monitoring system for a dewar, in accordance with various embodiments.

FIG. 6B illustrates a cable routing configuration for a dewar, in accordance with various embodiments.

FIG. 7 illustrates a cross-sectional view of a fitting for use in a cable routing configuration for a dewar, in accordance with various embodiments.

### DETAILED DESCRIPTION

The following detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular component or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Typical dewar monitoring devices utilize an electrically conductive cable that is routed in one of several typical configurations into the storage area of the cryogenic dewar. As described further herein, at least two routing configurations have drawbacks in addition to the aforementioned significant heat leak into the cryogenic dewar.

The first cable routing configuration is typically through an aperture disposed through the neck cork of the cryogenic dewar. With the cable running through the inside of the neck cork, every time the cork is removed to access the payload within the cryogenic dewar, the temperature sensed by the temperature sensor increases because the sensor at the end of the cable is removed from the cryogenic storage area and exposed to normal atmospheric temperatures. In this case, possible audible alarms have to be silenced and possible visual alarms canceled on the monitoring device, and any possible temperature records must be noted with explanations of the temperature spikes.

The second cable routing configuration is typically between the outside of the neck cork and the inside of the neck tube. With the cable running between the outside of the neck cork and the inside of the neck tube, the cable can be damaged from the insertion and removal of both the neck cork and payload, rendering the monitor useless. It is also possible that a fray in the cable could rip the protective plastic covering of the sample or other payload during insertion and removal of the payload, thus contaminating the tissue or payload, which would need to be discarded. This routing also adds unwanted thermal heat leak into the dewar reducing the dewar thermal performance.

Accordingly, disclosed herein is an improved cable routing configuration of a cryogenic dewar. The cable routing configuration eliminates the drawbacks of the first cable routing configuration and the second cable routing configuration as outlined above.

In various embodiments, the improved cable routing configuration includes a sensor cable routed along a radially outer surface of a neck tube of the cryogenic dewar. In various embodiments, the radially outer surface is defined axially between a first shoulder and a second shoulder. The first shoulder can define a first axial surface and the second shoulder can define a second axial surface. The first axial surface of the first shoulder, the radially outer surface, and the second axially surface of the second shoulder can at least partially define an annular cavity.

With the annular cavity, the cable can be extremely small in diameter relative to typical cables for temperature monitoring of a dewar (i.e., less than 0.20 inches (0.51 cm), less than 0.15 inches (0.38 cm), or less than 0.13 inches (0.33 cm)). In various embodiments, by having a smaller diameter relative to typical cables for temperature monitoring of a dewar, the cable will be protected from the potential damage caused by the second cable routing configuration as outlined above. In various embodiments, by having a small diameter cable, as disclosed herein, the improved cable routing configuration will greatly reduce the heat inleak of typical cables of a much larger diameter utilized in typical cable configurations, thus significantly increasing the duration of the refrigerant used in the cryogenic dewar.

In various embodiments, a neck tube assembly can include a cable, relatively small in diameter compared to typical sensor cables, that passes into a first aperture disposed through a first radial flange of the neck tube, through the annular cavity, and out a second aperture disposed through a second radial flange of the neck tube. In this regard, the first radial flange and the second radial flange can each include an aperture that extends axially through the radial flange of the neck tube from a longitudinal end defined by the radial flange to the axial surface of the shoulder that partially defines the annular cavity. Stated another way, the cable can be routed from a top side of the dewar through the first radial flange of the neck tube, into the annular cavity at least partially defined by the neck tube, and out the second radial flange of the neck tube to an internal cavity of the dewar. In this regard, a temperature sensor can be installed within the internal cavity of the dewar and the cable can be routed in a manner that greatly reduces a heat inleak relative to typical cable routing configurations. In various embodiments, the apertures disposed through the radial flanges can be sealed to be vacuum-tight (e.g., with epoxy, or any other suitable sealant).

In various embodiments, the sensor cable can have the sensor-end of the cable located in one of two places: (1) outside of the dewar inner top; or (2) inside of the dewar inner top. In various embodiments, by having the location outside of the dewar inner top, the sensor cable can only have to pass through a single aperture into the annular cavity, reducing manufacturing steps for producing a neck tube assembly. In various embodiments, by having the sensor cable attached to the sensor inside of the dewar inner top, the cable will have to pass through two apertures. However, the location may provide slightly more accurate temperature measurements, in accordance with various embodiments.

In various embodiments, the improved sensor cable routing configuration can be independent of a neck tube for a dewar. For example, the cable can be routed through a fitting configured to be coupled to an outer shell of the dewar (e.g., via welding, brazing, or the like). In various embodiments, the fitting can include an aperture disposed therethrough. The aperture can be configured to receive the cable. In various embodiments, after the cable is disposed through the aperture of the fitting, the aperture can be sealed vacuum tight (e.g., via an epoxy or any other suitable sealant). In various embodiments, similar to the neck tube configuration, the sensor end of the cable can be disposed outside of the dewar inner top or inside of the dewar inner top. The present disclosure is not limited in this regard.

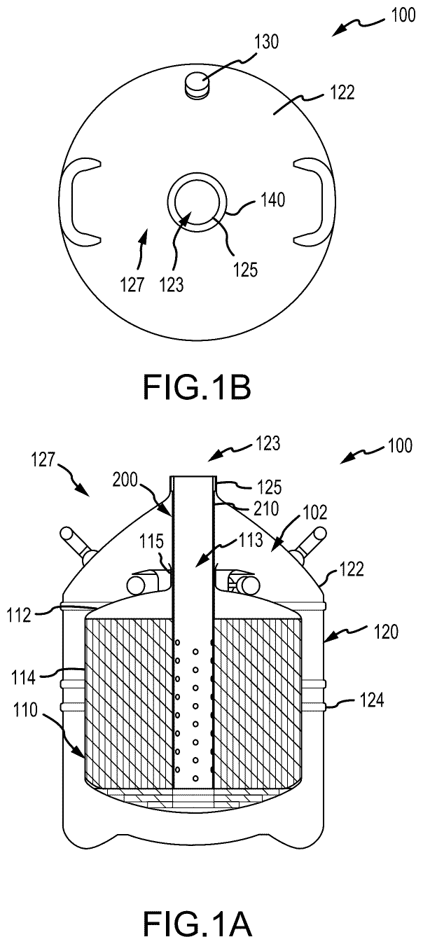

Referring to FIGS. 1A and 1B, a cross-sectional view (FIG. 1A) and a top-down view (FIG. 1B) of a dewar 100 are illustrated in accordance with various embodiments. The dewar 100 includes an inner vessel 110 positioned within an outer vessel 120 with an insulation space 102 formed between.

The inner vessel 110 includes an inner upper head 112 and an inner lower head 114. The inner upper head 112 and the inner lower head 114 may be coupled together (i.e., via welding, brazing, etc.) to form the inner vessel 110. The inner upper head 112 includes an opening 113. The opening 113 can be disposed in a center position of the inner upper head 112. The opening 113 is configured to receive a neck tube assembly 200, as described herein. For example, the opening 113 can include a cross-sectional shape defined in an axial plane that is complementary to a cross-sectional shape of a portion of the neck tube assembly 200 that interfaces with the opening 113 as described further herein. “Complementary” as referred to herein is defined as a first perimeter shape that is within. 0.05 inches (0.13 cm) profile of a second perimeter shape at a respective axial location.

The opening 113 further includes a flange 115. The flange 115 may extend axially or at least partially axially from the opening 113 along the circumference of the opening 113 such that the flange 115 forms a cylindrical inlet. In various embodiments, the flange 115 is configured to interface with the neck tube assembly 200, as described further herein. The inner upper head 112 may be configured in a generally arcuate shape such that the inner upper head 112 extends from the opening 113 to the inner lower head 114 in a downward slope. Thus, the inner upper head 112 may have a generally arcuate cross section so that the inner upper head 112 is a dome. The inner lower head 114 may be generally cylindrical.

Similarly, the outer vessel 120 includes an outer upper head 122 and an outer lower head 124. The outer upper head 122 and the outer lower head 124 may be coupled together (i.e., via welding, brazing, etc.) to form the outer vessel 120. The inner upper head 112, the inner lower head 114, the outer upper head 122, and the outer lower head 124 can each be constructed from a flat metal alloy (e.g., an aluminum alloy, a titanium alloy, a nickel alloy, a stainless-steel alloy, or the like). In various embodiments, the inner upper head 112, the inner lower head 114, the outer upper head 122, and the outer lower head 124 are each constructed from a flat aluminum alloy. The outer upper head 122 may include an opening 123. The opening 123 may be disposed in a center position along a central region 127 of the outer upper head 122. Similar to the opening 113 of the inner vessel 110, the opening 123 of the outer vessel 120 is configured to receive the neck tube assembly 200, as described further herein. For example, the opening 123 can include a cross-sectional shape defined in an axial plane that is complementary to a cross-sectional shape of a portion of the neck tube assembly 200 that interfaces with the opening 123 as described further herein.

In various embodiments, the opening 123 receives the same neck tube assembly 200 received by the opening 113 of the inner vessel 110. The opening 123 is defined by a flange 125. The flange 125 may extend axially or at least partially axially, from a top portion of the outer upper head 122 such that the flange 115 forms a cylindrical inlet that defines the opening 123. The outer upper head 122 may be configured in a generally arcuate shape such that the outer upper head 122 extends from the flange 125 to the outer lower head 124 in a second downward slope. The second downward slope may be greater than the first downward slope. The outer lower head 124 may be generally cylindrical. “Generally cylindrical” as referred to herein is defined as a shape having a profile tolerance of 2 inches (5.1 cm) from a nominal cylindrical shape. Although described as being generally cylindrical, the present disclosure is not limited in this regard. For example, various other shapes for the outer lower head 124 are within the scope of this disclosure.

The inner vessel 110, which is configured to store the biological material, is assembled and joined together (e.g., via welding, brazing, or the like). The inner vessel 110 can be wrapped with multi-layer radiant-reflective material and inserted into outer vessel 120 during assembly (e.g., positioned within the outer lower head 124). The outer lower head 124 may then receive the outer upper head 122, which is joined to the outer lower head 124 (e.g., via welding, brazing, or the like), so that an interior chamber containing the inner vessel 110 is formed, comprising the insulation space 102 between the inner vessel 110 and the outer vessel 120.

The dewar 100 may further include a valve 130. The valve 130 may be disposed on an outer surface (e.g., opposite the inner chamber) of the outer vessel 120 (e.g., an outer surface of the outer upper head 122). The valve 130 may be configured to couple with a vacuum (not shown). Accordingly, the valve 130 is configured to evacuate the air in the insulation space 102, providing a vacuum insulation within the dewar 100.

The dewar 100 includes a neck tube assembly 200. In various embodiments, the neck tube assembly 200 includes at least a portion of a cable routing configuration, as described further herein. The cable routing configuration can route a cable to a temperature sensor disposed within the dewar 100 (e.g., within the inner vessel 110 or coupled externally to the inner vessel 110), in accordance with various embodiments. In various embodiments, the neck tube assembly 200 can comprise a neck tube 210 (e.g., a one-piece neck tube, such as a monolithic tube component). Although described herein as neck tube 210 being a one-piece neck tube, the present disclosure is not limited in this regard. For example, a neck tube assembly 200 with a neck tube that is formed separately from a retainer of the neck tube is within the scope of this disclosure. However, in various embodiments, a one-piece neck tube can provide improved sealing, relative to a multi-piece neck tube assembly, by providing fewer leakage paths, in accordance with various embodiments.

The neck tube 210 can be a one-piece dewar neck tube with an integrated retainer (i.e., formed from a single piece), thus preventing cold nitrogen gas from fully escaping the dewar 100 if the dewar 100 is inverted, for example. The neck tube 210 is configured to extend between the inner vessel 110 and the outer vessel 120. Particularly, the neck tube 210 extends from the inner lower head 114 through to the outer upper head 122. The neck tube 210 is configured to be received by the opening 113 of the inner vessel 110 and the opening 123 of the outer vessel 120. For instance, the neck tube 210 may be attached to and protruding from the inner upper head 112 and extending to the outer upper head 122. The neck tube 210 attaches the inner upper head 112 to the outer upper head 122. In various embodiments, the neck tube 210 is the only attachment between the inner upper head 112 and outer upper head 122. In various embodiments, the neck tube 210 attaches the inner upper head 112 and the outer upper head 122 and no other structures attach the inner upper head 112 and the outer upper head 122. The neck tube 210 is configured to allow access to the biological materials stored in the cryogenic dewar. The neck tube 210 may be approximately 20 inches in length (e.g., 20.0, 20.5, 20.8, 20.11 inches, inclusively), or about 510 millimeters in length (e.g., 509, 509.5, 510.8 millimeters, inclusively). The neck tube 210 may be other lengths as desired. Further, the neck tube 210 may be constructed of a composite material. For instance, the neck tube 210 may be constructed of glass-fiber reinforced epoxy resin. The neck tube 210 may be constructed of other materials.

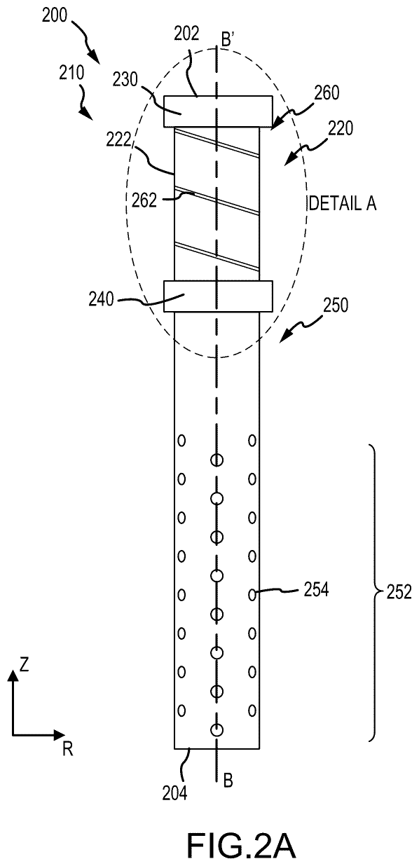

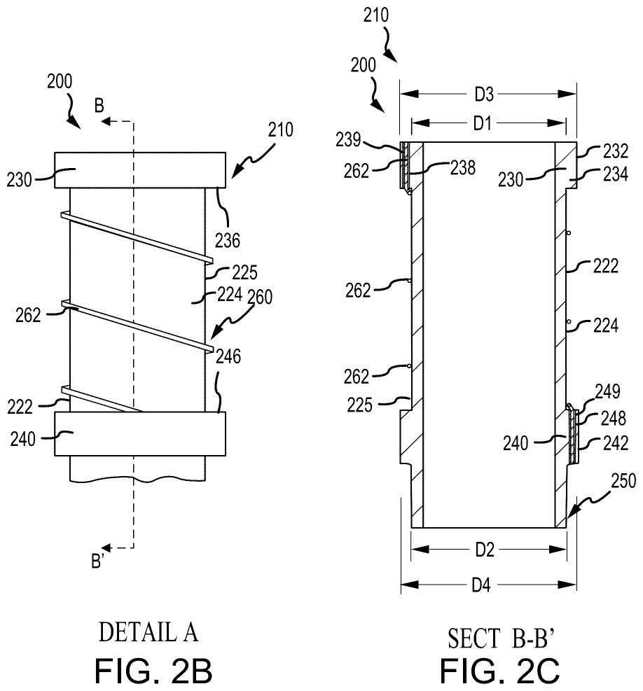

Referring now to FIGS. 2A, 2B, and 2C, a side view (FIG. 2A), a detail view of Detail A from FIG. 2A (FIG. 2B), and a cross-section along section line B-B′ of FIG. 2B (FIG. 2C) of the neck tube assembly 200 are illustrated, in accordance with various embodiments. The neck tube 210 extends longitudinally (i.e., in a Z-direction) from a first longitudinal end 202 (e.g., a top end of the neck tube 210) to a second longitudinal end 204 (e.g., a bottom end of the neck tube 210). In this regard, the neck tube 210 can define a central longitudinal axis B-B′. In various embodiments, a radial direction (R) is defined relative to the central longitudinal axis B-B′ of the neck tube 210.

The neck tube 210 includes an attachment end 220 and an elongated tubular element 250 extending longitudinally from the attachment end 220 to the second longitudinal end 204 (e.g., the bottom end of the neck tube 210). The attachment end 220 includes a first radial flange 230, a second radial flange 240, and a tubular element 222 extending longitudinally from the first radial flange 230 to the second radial flange 240. The first radial flange 230 is spaced apart longitudinally from the second radial flange 240. The first radial flange 230 is disposed at the first longitudinal end 202 of the neck tube 210. The first radial flange 230 is configured to couple with the outer vessel 120 as shown in FIG. 1A. Particularly, the first radial flange 230 is configured to couple with the outer upper head 122 of the outer vessel 120 as shown in FIG. 1A.

A radially outer surface of the tubular element 222 defines a first diameter D1. The first diameter D1 can be between 2.48 inches (62.9 mm) and 2.52 inches (64.0 mm), or approximately 2.5 inches (63.5 mm). The first diameter D1 of the tubular element 222 may be other diameters as desired. Similarly, a radially outer surface of the elongated tubular element 250 defines a second diameter D2. In various embodiments, the second diameter D2 is substantially equal to the first diameter D1. “Substantially equal,” as referred to herein is equal ±0.025 inches (0.0635 cm) or equal ±0.01 inches (0.025 cm). However, the present disclosure is not limited in this regard. For example, the first diameter D1 can be different from the second diameter D2 and still be within the scope of this disclosure. In various embodiments, by having the second diameter D2 substantially equal to the first diameter D1, the neck tube 210 may be easier and/or less expensive to manufacture, in accordance with various embodiments.

The first radial flange 230 of attachment end 220 of the neck tube 210 further defines a first sealing section 232. The first sealing section 232 is a radially outer surface of the first radial flange 230. In this regard, the first sealing section 232 can be configured to interface with the flange 125 of the outer vessel 120 to seal the opening 123 of the outer vessel 120 from an external environment. In various embodiments, the first radial flange 230 can be coupled to the outer vessel 120 of the dewar 100 from FIG. 1A by a press fit (i.e., an interference fit), an adhesive, a fastener, or the like. In various embodiments, the neck tube assembly 200 can comprise a seal (e.g., a polytetrafluoroethylene (PTFE) seal or the like). In this regard, the seal can interface with the first radial flange 230 and the flange 125 of the outer vessel 120 and can be configured to prevent leakage from the dewar 100 during operation, in accordance with various embodiments.

The first sealing section 232 has a third diameter D3 that is larger than the first diameter D1. In further embodiments, the third diameter D3 is a same diameter as the first diameter D1. In further embodiments, the third diameter D3 is a same diameter as the fourth diameter D4. In yet further embodiments, the third diameter D3 and the fourth diameter D4 are both a same diameter as the first diameter D1. The third diameter D3 is an outer diameter of a radially outer surface of the first radial flange 230 that defines the first sealing section 232. The third diameter D3 may be between 2.74 inches (69.7 mm) and 2.76 inches (70.2 mm), or approximately 2.75 inches (69.8 mm). The first radial flange 230 extends radially outward from an outer surface 224 (e.g., a radially outer surface) of the tubular element 222. The radial flange 234 can have an axial length measured from the first longitudinal end 202 of the neck tube 210 along the central longitudinal axis B-B′. In various embodiments, the third diameter D3 can remain substantially constant over the axial length of the first radial flange 230. In this regard, the first radial flange 230 is thickened radially relative to the tubular element 222 of the attachment end 220.

Similarly, the second radial flange 240 of attachment end 220 of the neck tube 210 further defines a second sealing section 242. The second sealing section 242 is a radially outer surface of the second radial flange 240. In this regard, the second sealing section 242 can be configured to interface with the flange 115 of the inner vessel 110 to seal the opening 113 of the inner vessel 110. In various embodiments, the second radial flange 240 can be coupled to the inner vessel 110 of the dewar 100 from FIG. 1A by a press fit (i.e., an interference fit, an adhesive, a fastener, or the like). In various embodiments, the neck tube assembly 200 can comprise a second seal (e.g., a polytetrafluoroethylene (PTFE) seal or the like). In this regard, the seal can interface with the second radial flange 240 and the flange 115 of the inner vessel 110 and can be configured to prevent leakage from the dewar 100 during operation, in accordance with various embodiments.

The second sealing section 242 has a fourth diameter D4 that is larger than the second diameter D2. The fourth diameter D4 is an outer diameter of a radially outer surface of the second radial flange 240 that defines the second sealing section 242. The fourth diameter D4 may be between 2.74 inches (69.7 mm) and 2.76 inches (70.2 mm), or approximately 2.75 inches (69.8 mm). The second radial flange 240 extends radially outward from the outer surface 224 of the tubular element 222. The second radial flange 240 can have an axial length measured along the central longitudinal axis B-B′. In various embodiments, the fourth diameter D4 can remain substantially constant over the axial length of the second radial flange 240. In this regard, the second radial flange 240 is thickened radially relative to the tubular element 222 of the attachment end 220 and the elongated tubular element 250 of the neck tube 210.

In various embodiments, a radial recess 225 is defined axially between the first radial flange 230 and the second radial flange 240. In this regard, a first axial surface 236 of the first radial flange 230, an outer surface 224 of tubular element 222 of attachment end 220, and a second axially surface 246 of the second radial flange 240 define the radial recess 225.

The elongated tubular element 250 of the neck tube 210 further includes a perforated area 252. The perforated area 252 is disposed along at least a portion of the elongated tubular element 250. The perforated area 252 comprises a plurality of perforations 254 (i.e., apertures), each perforation extending radially through the elongated tubular element 250. For instance, in accordance with various embodiments, the perforated area 252 may include 48 perforations, wherein the 48 perforations are in an 8×6 configuration. In various embodiments, other suitable amounts and configurations may be included. The present disclosure is not limited in this regard.

The elongated tubular element 250 of the neck tube 210 creates a barrier between the liquid nitrogen absorbent and a payload area of the dewar 100 which contains the biological material. The perforated area 252 allows access to the biological material in the payload area of the dewar 100 from FIGS. 1A-B. The perforated area 252 allows for charging of an absorbent material with liquid nitrogen prior to shipment of the biological material. For instance, the locations of the plurality of perforations 254, along with the single-piece design, will slow the escape of the cryogen in the non-upright-position-dewars during shipment, extending the holding time and viability of the biological samples inside the tank, in accordance with various embodiments. Particularly, the inner upper head 112 entraps cold nitrogen vapor when the dewar 100 is inverted, extending the length of time the payload will remain at cryogenic temperature, in accordance with various embodiments. The position of the plurality of perforations 254 along the elongated tubular element 250 of the neck tube 210 impacts the volume of cold nitrogen entrapped. If the perforated area 252 is located by a collar (e.g., disposed around the flange 115 of the inner upper head 112), the colder vapor will be entrapped, lengthening the cold temperature holding time. However, if the perforated area 252 is located too far away from the collar of the inner upper head 112, the tank will not charge with liquid nitrogen as quickly as if the perforated area 252 is closer to the collar of the inner upper head 112.

Referring back to FIGS. 1A and 1B, the dewar 100 includes a collar 140. The final joint between the neck tube assembly 200 and the outer vessel 120 is the collar 140. Stated another way, the collar 140 couples the neck tube assembly 200 to the outer vessel 120. The collar 140 is configured to secure the neck tube 210 to the outer vessel 120. For instance, when positioned, the first sealing section 232 (FIG. 2C) of the neck tube 210 is disposed within the flange 125 of the outer vessel 120. As such, the collar 140 is then disposed around the flange 125, and coupled using any fastening methods (e.g., a threaded coupling, a press fit, or the like). In various embodiments, the neck tube 210 of the neck tube assembly 200 may be coupled to the outer upper head 122 via an epoxy, magneform/crimping, or a combination thereof. The insulation space 102 between the inner vessel 110 and the outer vessel 120 is then evacuated via the valve 130 to complete the thermal isolation of the inner vessel 110.

Referring back to FIGS. 2A-C, the neck tube assembly 200 further comprises a cable routing configuration 260 for a temperature sensor (e.g., a thermocouple or the like) of a temperature monitoring system of a dewar (e.g., dewar 100 from FIGS. 1A and 1B). In various embodiments, the cable routing configuration 260 includes a cable 262. A “cable” as referred to herein can be a conduit configured to house a first conductive wire and a second conductive wire (e.g., of a thermocouple), or a conductive wire (e.g., of the thermocouple), or a plurality of conductive wires, as described further herein. For example, the cable 262 can include wires (e.g., a negative wire and a positive wire of a thermocouple) disposed therein, in accordance with various embodiments. In various embodiments, the cable 262 can be a first conductive wire (e.g., a base wire) and a second cable can be a second conductive wire, and both cables 262 can be routed as shown in FIGS. 2A-C in a manner where the cables 262 are spaced apart from each other throughout a respective routing. In such a configuration, the cable routing configuration would include two of the cable 262 (e.g., a negative wire and a positive wire of a thermocouple). The present disclosure is not limited in this regard. In various embodiments, when the cable 262 includes wires disposed therein, the cable 262 can further comprise insulation disposed therein. The insulation can be configured to electrically isolate the negative wire and the positive wire, in accordance with various embodiments.

In various embodiments, the cable 262 extends through an aperture 238 disposed axially (i.e., in the axial direction defined by the central longitudinal axis B-B′ of the neck tube 210), from a top axial surface of the neck tube 210 defined at the first longitudinal end 202, through the first radial flange 230, and into the radial recess 225 defined between the first radial flange 230 and the second radial flange 240.

In various embodiments, the cable 262 spirals along a radially outer surface defined by the radial recess 225 from the outlet of the aperture 238 towards the second radial flange 240. In various embodiments, the aperture 238 can be sealed to be vacuum-tight by a sealant 239 (e.g., with epoxy, or any other suitable sealant). In this regard, to limit a potential thermal leak along the path of the cable 262, the cable 262 is spiraled around the neck tube, so that the heat does not pass directly in a straight line up and out of the aperture 238 or conducted along the cable 262. In various embodiments, the cable may alternatively and/or additionally be spiraled underneath and or above an insulation layer of the inner vessel so as to spiral around at least a portion of the inner vessel. In various embodiments, the cable 262 extends through a second aperture (i.e., aperture 248) disposed axially through the second radial flange 240 from the radial recess 225 toward the second longitudinal end 204. In this regard, the cable 262 can be routed into a cavity of the inner vessel 110 of the dewar 100 from FIGS. 1A and 1B, in accordance with various embodiments. Accordingly, a temperature sensor (e.g., a measurement junction of a thermocouple) can be disposed within the cavity of the inner vessel 110 as described further herein. However, the present disclosure is not limited in this regard. For example, the temperature sensor can be coupled to an external surface of the inner vessel 110 and still be within the scope of this disclosure. In various embodiments, by coupling the temperature sensor to an external surface of the inner vessel 110, aperture 248 can be eliminated, reducing manufacturing steps and/or manufacturing costs, in accordance with various embodiments. In various embodiments, the aperture 248 can also be sealed to be vacuum-tight by a sealant 249 (e.g., with epoxy, or any other suitable sealant) and configured to prevent leakage from an internal cavity of the inner vessel 110 from FIG. 1.

In various embodiments, the apertures 238, 248 have a diameter that is substantially similar to an outer diameter of the cable 262. For example, the apertures 238, 248 can have an outer diameter that is between 0.000 inches (0.000 cm) and 0.02 inches (0.05 cm) greater than an outer diameter of the cable 262, or between 0.000 inches (0.000 cm) and 0.01 inches (0.025 cm) greater than an outer diameter of the cable. Outer diameter sizes for the apertures 238, 248 are provided merely for exemplary purposes, and one skilled in the art may recognize other sizes that would still be within the scope of this disclosure. By having a closer aperture diameter to cable diameter, a leakage path from an internal cavity of the dewar 100 from FIG. 1A can be minimized, in accordance with various embodiments.

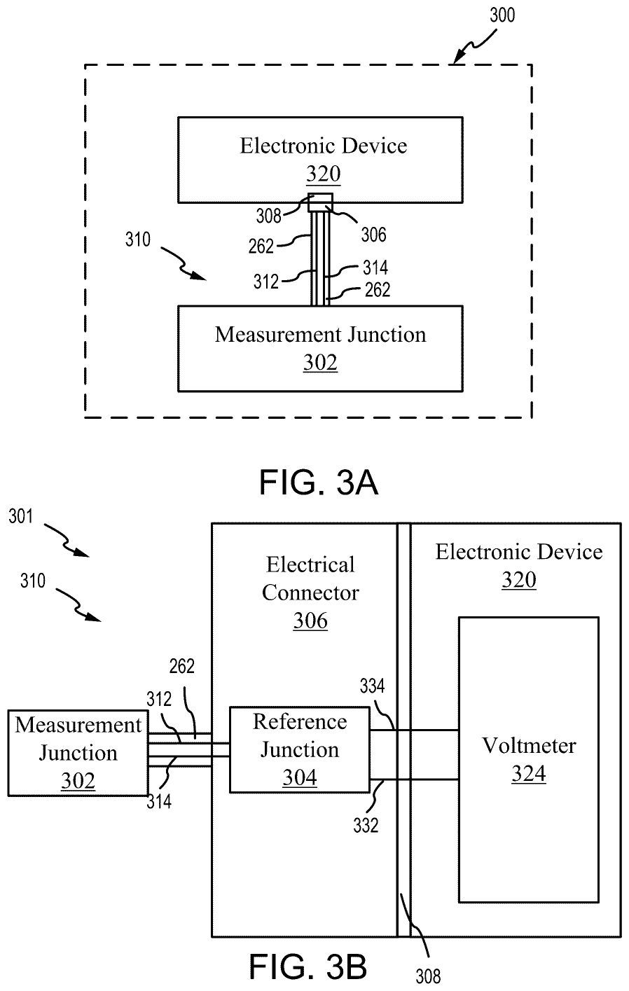

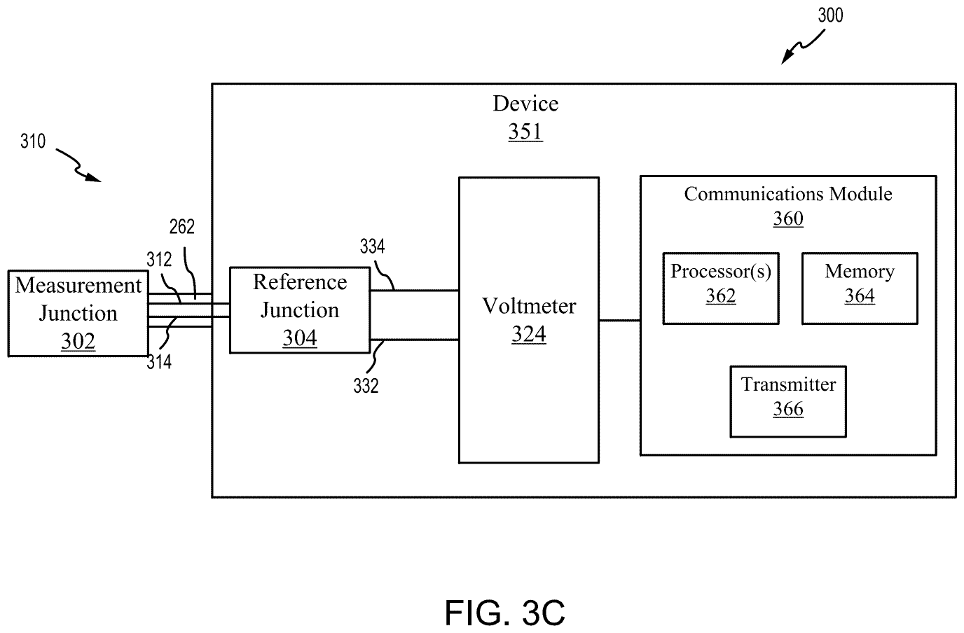

Referring now to FIGS. 3A-B, a schematic view of a temperature monitoring system 300 (FIG. 3A) for a dewar 100 from FIGS. 1A and 1B and an electrical circuit 301 (FIG. 3B) for the temperature monitoring system 300 are illustrated, in accordance with various embodiments. In various embodiments, the temperature monitoring system 300 includes a temperature sensor 310, such as a thermocouple or the like. Although described herein as including a thermocouple, the present disclosure is not limited in this regard. For example, the temperature sensor 310 could comprise a thermistor, or any other sensor configured to detect (or calculate) a temperature in a respective environment. The temperature sensor 310 can comprise a measurement junction 302, a wire 312 (e.g., a positive wire), a wire 314 (e.g., a negative wire), a reference junction 304, extension wires 332, 334, and a voltmeter 324. In response to the measurement junction having a dissimilar temperature from the reference junction, a voltage is generated in the electrical circuit 301 of the temperature sensor 310 which can be measured and corresponds to a temperature at the measurement junction 302.

Although described herein as being a measurement junction for a temperature sensor 310, the present disclosure is not limited in this regard. A “measurement junction”, as referred to herein, can be a junction of any sensor configured to measure a parameter for a respective sensor. For example, a measurement junction for a level sensor that is a float switch would be a location of the float switch, a measurement junction for an optical level sensor would be a location of an infrared emitter and a photodiode, etc.

In various embodiments, although described herein as including a temperature sensor 310, the present disclosure is not limited in this regard. For example, any type of sensor for use in a cryogenic dewar (e.g., dewar 100 from FIGS. 1A and 1B) is within the scope of this disclosure. For example, a level measurement sensor (e.g., for measuring/determining a liquid level within the dewar 100 from FIG. 1A and 1B) or any other type of sensor can be used instead of, or in addition to, the temperature sensor 310 and would be within the scope of this disclosure, in accordance with various embodiments.

In various embodiments, the wire 312 and the wire 314 are routed through the cable 262 to an electrical connector 306. In various embodiments, the wire 312 and the wire 314 are each a cable 262 that is routed in the manner disclosed herein. The present disclosure is not limited in this regard. In various embodiments, the temperature sensor 310 is configured for cryogenic temperatures. In this regard, the wire 312 can be made of chromel and the wire 314 can be made of alumel, the wire 312 can be made of copper and the wire 314 can be made of constantan, or the wire 312 can be made of chromel and the wire 314 can be made of constantan. The present disclosure is not limited in this regard, and any wire combination that forms a thermocouple for use in cryogenic temperatures is within the scope of this disclosure. Moreover, any temperature detection device, may be contemplated. For example a resistance temperature detector (RTD) may be implemented. Moreover, the temperature device may be for use at temperatures other than cryogenic. For example, temperatures warmer than cryogenic may be contemplated. In various instances, the temperature may be a dry ice temperature. For instance, the temperature may be at or around-80 degrees Celsius. The temperature may be a water ice temperature. For instance the temperature may be at or around 0 degrees Celsius. Other temperatures may also be contemplated.

In various embodiments, the reference junction 304 is disposed in the electrical connector 306. In various embodiments, the reference junction 304 is disposed adjacent to, or in, the electrical connector 306. However, the present disclosure is not limited in this regard. For example, the reference junction 304 can be disposed within the electronic device 320, or separate from the electrical connector (i.e., in a reference junction box) or the like, and still be within the scope of this disclosure, and the voltmeter 324 can be disposed within the electronic device 320. However, the present disclosure is not limited in this regard. For example, the reference junction 304 can be disposed in the electrical connector 306 and still be within the scope of this disclosure. In various embodiments, a temperature probe is also disposed at the reference junction to provide a reference temperature for the temperature monitoring system 300. However, the present disclosure is not limited in this regard. For example, an average temperature at the reference junction 304 can be programmed into a controller of the electronic device 320 and still be within the scope of this disclosure.

In various embodiments, the cable 262 comprises a first conductive wire (e.g., wire 312) and a second conductive wire (e.g., wire 314) disposed therein and extending from the measurement junction 302 to an electrical connector 306. Although illustrated as being coupled to the electrical connector 306, the present disclosure is not limited in this regard. For example, the first conductive wire (e.g., wire 312) and the second conductive wire (e.g., wire 314) can extend directly to the electronic device 320 (e.g., for a temperature monitoring system 300 that has an electronic device 320 mounted to a dewar 100 from FIG. 1A or 1B), in accordance with various embodiments.

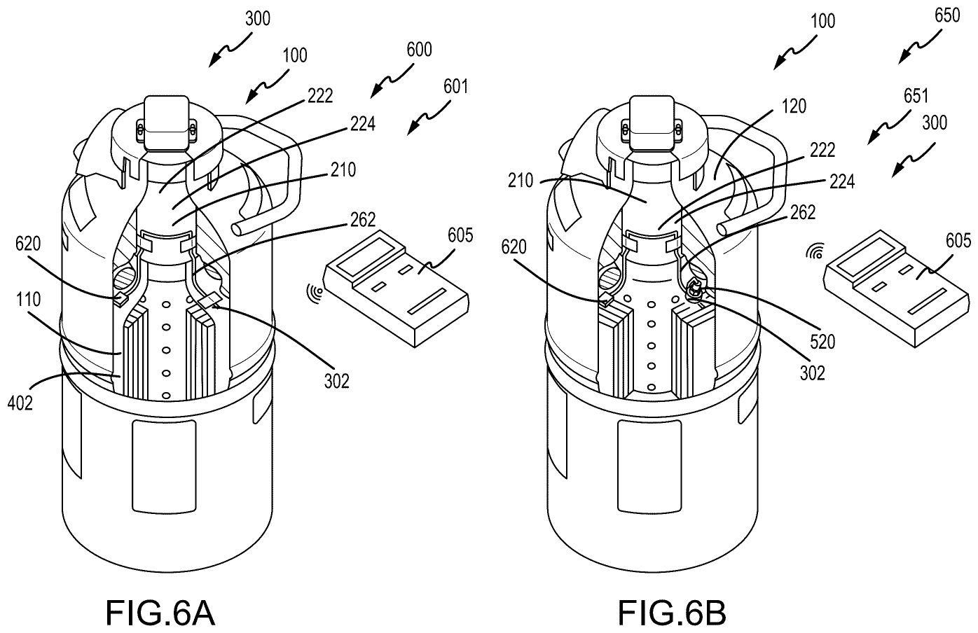

In various embodiments, the temperature monitoring system 300 comprises a measurement junction 302 electrically coupled to an electronic device 320 by the cable 262 (e.g., as shown in FIGS. 2A-C). In various embodiments, the electronic device 320 can comprise a display coupled externally to the dewar 100 from FIG. 1A (e.g., to display a temperature measured from the measurement junction 302), a transmitter (e.g., to wirelessly transmit a temperature measured from the measurement junction 302 to a monitoring device as described in FIGS. 3C, 6A, and 6B further herein), a controller to determine a temperature within the inner vessel 110 of the dewar 100 from FIG. 1A based on the temperature measurement from the measurement junction 302, or the like. The present disclosure is not limited in this regard.

The measurement junction 302 can be coupled to any electronic device for facilitating monitoring of a temperature within the inner vessel 110 of the dewar 100 from FIG. 1A and be within the scope of this disclosure. In various embodiments, as described further herein, the cable 262 can be configured to removably couple to the electronic device 320. For example, the cable 262 can include an electrical connector 306 configured to be coupled to an electric port 308 of the electronic device 320 to form an electrical interface. In this regard, any electrical connector 306 (e.g., a male connector, a female connector, etc.) for forming a typical electrical interface is within the scope of this disclosure. In this regard, in response to coupling the electrical connector 306 to the electric port 308, a temperature measured by the measurement junction 302 can be displayed thereon, in accordance with various embodiments.

Referring now to FIG. 3C, schematic view of a temperature sensor 310 with like numerals depicting like elements is illustrated, in accordance with various embodiments. The temperature sensor 310 includes the reference junction 304, the voltmeter 324, and a communications module disposed within a device 351 (e.g., a fitting, a mount, a beacon, or the like). Although illustrated as including the reference junction 304 and the voltmeter 324 within a single fitting (e.g., device 351), the present disclosure is not limited in this regard. For example, with reference to FIGS. 3C and 6B, the reference junction 304 could be disposed in one fitting (e.g., fitting 520), and the voltmeter 324 could be disposed in the device 351, or the device 351 could include both the voltmeter 324 and the reference junction 304. Both configurations are still within the scope of this disclosure. In this regard, the device 351 can be configured as a dual device that is adaptable to be coupled to a vessel (e.g., inner vessel 110 or outer vessel 120 from FIGS. 1A and 1B) and configured to communicate data from the temperature sensor 310 to an external device (e.g., an electronic device 605 from FIGS. 6A and 6B). In various embodiments, although described as being within a device 351, the electronic system of the temperature sensor 310 and the communications module 360 is not limited in this regard.

With continued reference to FIG. 3C, in various embodiments, the temperature sensor 310 (e.g., the voltmeter 324 of the temperature sensor 310) is in electrical communication with a communications module 360. The communications module 360 can comprise one or more processors 362, a memory 364, and a transmitter 366 (e.g., a transmitter only or a transceiver). In this regard, the communications module 360 can be configured to receive temperature readings from the temperature sensor 310 and transmit the temperature readings to an external device (e.g., an electronic device 605 from FIGS. 6A and 6B).

In various embodiments, communications module 360 may be configured as a central network element or hub to access various systems and components of temperature monitoring system 300. In various embodiments, communications module 360 may comprise a single processor. In various embodiments, the communications module 360 may include one or more processors and/or one or more tangible, non-transitory memories (e.g., memory 364) and be capable of implementing logic. Each processor can be a general-purpose processor, a digital signal processor (“DSP”), an application specific integrated circuit (“ASIC”), a field programmable gate array (“FPGA”), or other programmable logic device, discrete gate or transistor logic, discrete hardware components, or any combination thereof. The communications module 360 can include a processor configured to implement various logical operations in response to execution of instructions, for example, instructions stored on a non-transitory, tangible, computer-readable medium configured to communicate with communications module 360.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In various embodiments, the communications module 360 and the transmitter 366 can be configured to transmit communication wirelessly via Bluetooth® communications, near field communications (NFC), low energy Bluetooth® communications, or the like. The present disclosure is not limited in this regard.

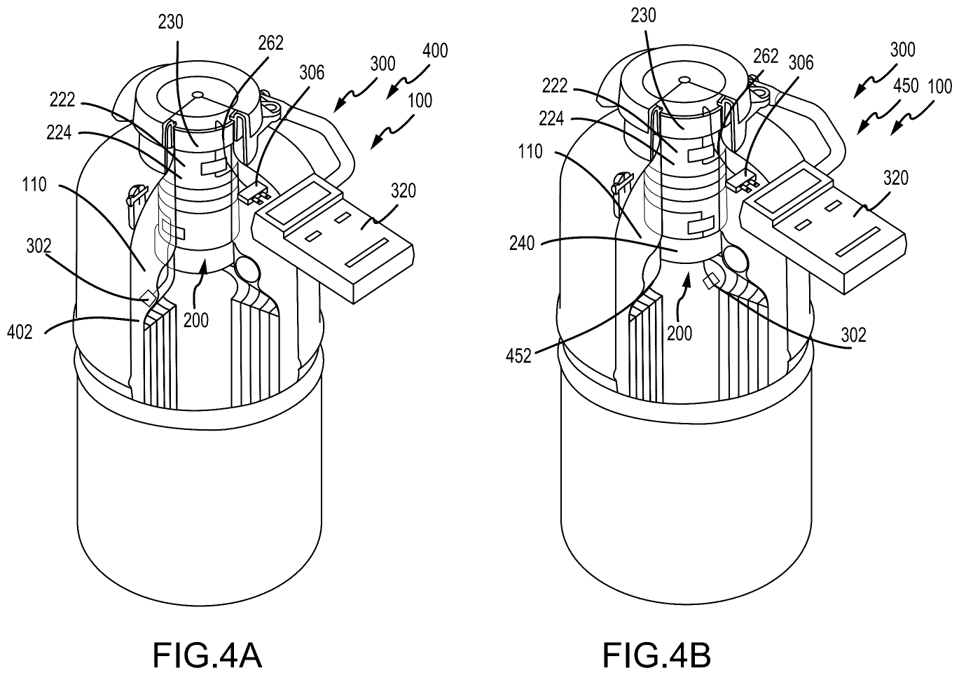

Referring now to FIG. 4A, a temperature monitoring system 300 with a cable routing configuration 400 having the measurement junction 302 coupled to an outer surface 402 of the inner vessel 110 (FIG. 4A) is illustrated, with like numerals depicting like element, in accordance with various embodiments. The cable routing configuration 400 can comprise the cable 262 extending from the electrical connector 306 through the first radial flange 230 of the neck tube assembly 200, as described previously herein, around the outer surface 224 of the tubular element 222 (e.g., in a spiraling manner or the like) to the measurement junction 302. In various embodiments, the measurement junction 302 is coupled to an outer surface 402 of the inner vessel 110. In this regard, the cable routing configuration 400 can reduce a number of apertures in the neck tube assembly 200 by not placing the measurement junction within the inner vessel 110. Stated another way, a manufacturing step for manufacturing the neck tube assembly 200 can be eliminated relative to a cable routing configuration that places the measurement junction 302 within the inner vessel 110.

In various embodiments, by coupling the measurement junction 302 to the outer surface 402 of the inner vessel 110, the electronic device 320 may have a controller configured to calculate a temperature within the inner vessel 110 based on a temperature measurement from the measurement junction 302. In this regard, the temperature measurement at the measurement junction 302 may be utilized to estimate a temperature within the inner vessel 110 (e.g., based on thermal conductivity of the inner vessel 110 or the like).

In various embodiments, the measurement junction 302 can be coupled to the outer surface 402 of the inner vessel 110 by any method known in the art. For example, the measurement junction 302 can be coupled to the outer surface 402 of the inner vessel 110 by an adhesive tape, an adhesive pad, epoxy, or the like. The present disclosure is not limited in this regard.

In various embodiments, the cable 262 can be coupled to the outer surface 224 of the tubular element 222 at any number of local locations. For example, the cable 262 can be coupled to the tubular element 222 proximate an outlet of the aperture in the first radial flange 230 and proximate the second radial flange 240. In this regard, the cable 262 can be wound tightly around the outer surface 224 of the tubular element 222 and secured to the tubular element via the couplings. However, the present disclosure is not limited in this regard. For example, the cable 262 may not be coupled to the tubular element 222 and still be within the scope of this disclosure. In various embodiments, the cable 262 can have a corresponding cable length that is in contact with the tubular element 222. In various embodiments, the cable 262 can be coupled to the tubular element 222 along the entire cable length that is in contact with the tubular element 222 (e.g., via an adhesive, or the like). In various embodiments, the cable 262 can be cured to the tubular element 222 during the manufacturing process of the neck tube assembly 200. The present disclosure is not limited in this regard. In various embodiments, the cable 262 would be held in place on tubular element 222 with epoxy and/or multi-layer radiant-reflective material. However, the present disclosure is not limited in this regard.

Referring now to FIG. 4B, a temperature monitoring system 300 with the measurement junction 302 disposed within the inner vessel 110 (FIG. 4B) is illustrated, with like numerals depicting like elements. The temperature monitoring system 300 of FIG. 4B includes a cable routing configuration 450. The cable routing configuration 450 can comprise the cable 262 extending from the electrical connector 306 through the first radial flange 230 of the neck tube assembly 200, as described previously herein, around the outer surface 224 of the tubular element 222 (e.g., in a spiraling manner or the like), through the second radial flange 240 of the neck tube assembly 200 to the measurement junction 302. In various embodiments, the measurement junction 302 is coupled to an inner surface 452 of the inner vessel 110. In this regard, the cable routing configuration 450 can end with the measurement junction 302 within the inner vessel 110. Stated another way, by having the measurement junction 302 within the inner vessel 110, a controller of the electronic device 320 may not have to calculate a temperature within the inner vessel 110 and may utilize the temperature measured at the measurement junction for determining the temperature within the inner vessel 110. In various embodiments, the electronic device 320 may still include a controller that calculates a temperature within the inner vessel 110 (e.g., if there are temperature variations from the inner surface 452 of the inner vessel 110 to a center or a payload area of the inner vessel 110).

In various embodiments, the measurement junction 302 can be coupled to the inner surface 452 of the inner vessel 110 by any method known in the art. For example, the measurement junction 302 can be coupled to the inner surface by an adhesive tape, an adhesive pad, epoxy, or the like. The present disclosure is not limited in this regard.

In various embodiments, the cable 262 can be coupled to the outer surface 224 of the tubular element 222 as described previously herein with respect to FIG. 4B. The present disclosure is not limited in this regard.

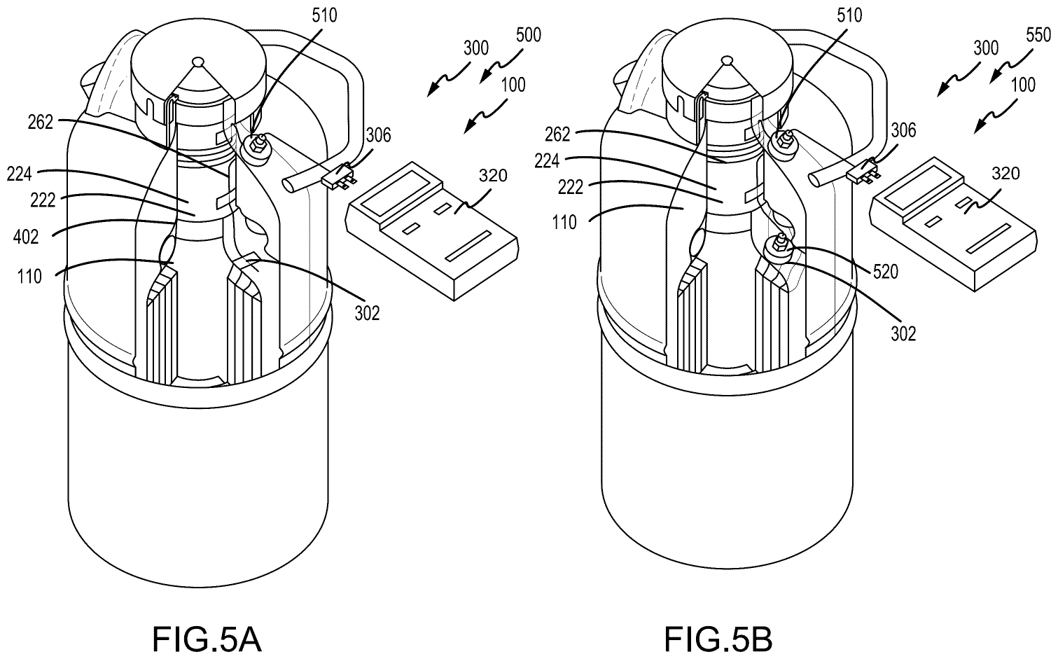

Referring now to FIG. 5A, a temperature monitoring system 300 with the measurement junction 302 coupled to an outer surface of the inner vessel 110 and routed through a fitting 510 (FIG. 5A), is illustrated with like numerals depicting like elements, in accordance with various embodiments. The temperature monitoring system 300 of FIG. 5 comprises a cable routing configuration 500. The cable routing configuration 500 can comprise the cable 262 extending from the electrical connector 306 through the fitting 510, around the outer surface 224 of the tubular element 222 (e.g., in a spiraling manner or the like) to the measurement junction 302. In various embodiments, the measurement junction 302 is coupled to an outer surface 402 of the inner vessel 110. In this regard, the cable routing configuration 500 can eliminate a second fitting (i.e., fitting 520 from FIG. 5B), resulting in a lower cost for the dewar 100.

In various embodiments, the measurement junction 302 can be coupled to the outer surface 402 of the inner vessel 110 by any method known in the art. For example, the measurement junction 302 can be coupled to the outer surface by an adhesive tape, an adhesive pad, epoxy, or the like. The present disclosure is not limited in this regard.

Referring now to FIG. 5B, a temperature monitoring system 300 with the measurement junction 302 disposed within the inner vessel 110 and routed through a second fitting (i.e., fitting 520) to the fitting 510, is illustrated, with like numerals depicting like elements, in accordance with various embodiments. The temperature monitoring system 300 of FIG. 5B comprises a cable routing configuration 550. The cable routing configuration 550 can comprise the cable 262 extending from the electrical connector 306 through the fitting 510, around the outer surface 224 of the tubular element 222 (e.g., in a spiraling manner or the like), and through the second fitting (i.e., fitting 520) to the measurement junction 302. In various embodiments, the measurement junction 302 is disposed within the second fitting (i.e., fitting 520) (i.e., in thermal communication with an internal cavity of the inner vessel 110).

Referring now to FIGS. 6A and 6B, a temperature monitoring system 300 is illustrated with like numerals depicting like elements, in accordance with various embodiments. The temperature monitoring system of FIG. 6A includes the measurement junction 302 coupled to an outer surface 402 of the inner vessel 110 and routed to a device 620. The temperature monitoring system 300 of FIG. 6B includes the measurement junction 302 disposed within the inner vessel 110 and routed through a fitting 520 that is coupled to the inner vessel 110 to the device 620.

The temperature monitoring system 300 of FIGS. 6A and 6B is configured for wireless communication with an electronic device 605 to form wireless configurations 601, 651. In various embodiments, the wireless configurations 601, 651 can each comprise a device 620 coupled to the inner vessel 110 (e.g., the inner upper head 112 of the inner vessel 110). Although illustrated as being coupled to the inner vessel 110, the present disclosure is not limited in this regard. For example, the device 620 can be coupled to the neck tube 210, the outer vessel 120, or the like. The present disclosure is not limited in this regard. In various embodiments, the wireless configuration 601, 651 from FIGS. 6A and 6B can facilitate a configuration of the temperature monitoring system 300 that is not only wireless but prevents a potential leakage path that could be generated from temperature monitoring system 300 from FIGS. 4A, 4B, 5A, and 5B, in accordance with various embodiments.

In various embodiments, the device 620 of the wireless configuration 601, 651 from FIGS. 6A and 6B is in accordance with the device 351 from FIG. 3C (e.g., the device 620 includes at least a portion of the temperature sensor 310 and a communications module 360 in communication with the portion of the temperature sensor 310). In this regard, the device 620 can be configured to transmit temperature sensor data from the device 620 (e.g., via the communications module 360) to an external device (e.g., electronic device 605). In various embodiments, the electronic device 605 can comprise a phone, a tablet, a computer, or the like. The present disclosure is not limited in this regard.

Referring now to FIG. 6A, a cable routing configuration 600 is illustrated, in accordance with various embodiments. The cable routing configuration 600 can comprise the cable 262 extending from the device 620, along the outer surface 224 of the tubular element 222 to the measurement junction 302. In various embodiments, the measurement junction 302 is coupled to an outer surface 402 of the inner vessel 110. In this regard, the cable routing configuration 600 can be short and minimize any additional manufacturing steps of the neck tube 210, in accordance with various embodiments. In the wireless configuration 601, the reference junction 304 and the voltmeter 324 of the temperature sensor 310 from FIG. 3A can be disposed in the device 620.

Referring now to FIG. 6B, a cable routing configuration 650 is illustrated, in accordance with various embodiments. The cable routing configuration 650 can comprise the cable 262 extending from the device 620, around the outer surface 224 of the tubular element 222, through the fitting 520 to the measurement junction 302. In various embodiments, the measurement junction 302 is disposed within the fitting 520, within the inner vessel 110, or the like. Stated another way, the measurement junction 302 is in thermal communication with an internal cavity of the inner vessel 110, in accordance with various embodiments. In various embodiments, in the wireless configuration 651, the reference junction 304 and the voltmeter 324 can be disposed within the fitting 520 or within the device 620. The present disclosure is not limited in this regard.

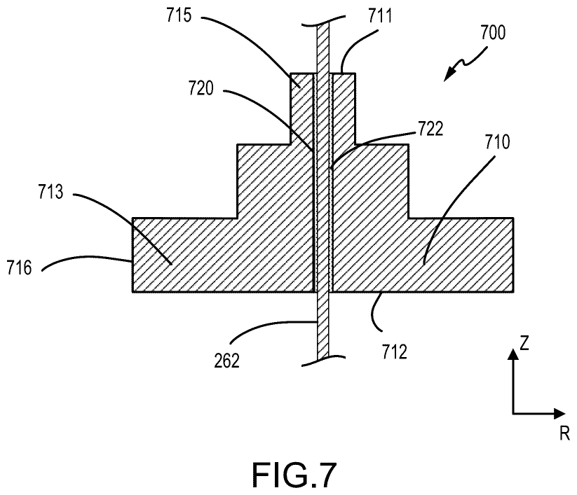

Referring now to FIG. 7, a cross-sectional view of a fitting 700 (i.e., fitting 510 and/or fitting 520) with a cable 262 disposed therethrough is illustrated, in accordance with various embodiments. In various embodiments, the fitting 700 comprises a main body 710 and an aperture 720 disposed therethrough. In various embodiments, the aperture 720 extends longitudinally (i.e., in the Z-direction) from a first longitudinal end 711 to a second longitudinal end 712. In various embodiments, the main body 710 comprises a base portion 713, and a top portion 715. In various embodiments, the base portion 713 defines a flange 716. The flange 716 can be configured to be joined to a vessel (e.g., inner vessel 110 or outer vessel 120). For example, the flange 716 can include a thickness that is substantially equal to a thickness of a vessel that the fitting 700 is configured to be coupled to. In this regard, the flange 716 can be welded to the vessel (e.g., inner vessel 110 or outer vessel 120). In various embodiments, the main body 710 can comprise a same material as the vessel. In various embodiments, the flange 716 can include a shape that is substantially complementary to an aperture disposed through a vessel that the fitting is configured to be coupled to. In various embodiments, the flange 716 defines a contour that is similar to a contour of the vessel the flange 716 is configured to be coupled to. In this regard, the fitting 700 can be configured to be joined to the vessel (e.g., via welding, brazing, or the like), in accordance with various embodiments.

In various embodiments, the aperture 720 is configured to receive the cable 262. In this regard, the aperture 720 can have a diameter that is substantially similar to an outer diameter of the cable 262. For example, the aperture 720 can have an outer diameter that is between 0.000 inches (0.000 cm) and 0.02 inches (0.05 cm) greater than an outer diameter of the cable 262, or between 0.000 inches (0.000 cm) and 0.01 inches (0.025 cm) greater than an outer diameter of the cable. Outer diameter sizes for the aperture 720 are provided merely for exemplary purposes, and one skilled in the art may recognize other sizes that would still be within the scope of this disclosure. By having a closer aperture diameter to cable diameter, a leakage path from an internal cavity of the dewar 100 can be minimized, in accordance with various embodiments. In various embodiments, the aperture 720 can also be sealed to be vacuum-tight by a sealant 722 in a similar manner to apertures 238, 248 described previously herein.

In various embodiments, in comparison to a typical temperature monitoring system of a dewar having a cable running through the inside of a cork disposed in the neck tube assembly during operation, by having a cable routing configuration in accordance with the cable routing configurations 400, 450, 500, 550, 600, 650 from FIGS. 4A, 4B, 5A, 5B, 6A, 6B as disclosed herein, the temperature monitoring system 300 is not affected by a cork being removed from the neck tube assembly 200 to access the payload during operation. Stated another way, the measurement junction 302 remains within the dewar during removal of the payload, preventing possible audible alarms that have to be silenced and/or possible visual alarms canceled on a monitoring device (e.g., an electronic device 320). Additionally, in various embodiments, the cable routing configurations 400, 450, 500, 550, 600, and 650 from FIGS. 4A, 4B, 5A, 5B, 6A, 6B, as disclosed herein, can prevent possible temperature records that have to be noted with explanations of temperature spikes as the measurement junction 302 remains within the dewar 100 (e.g., on an outer surface 402 of the inner vessel 110 or on an inner surface 452 of the inner vessel 110), in accordance with various embodiments.

In various embodiments, in comparison to a typical temperature monitoring system of a dewar with the cable running between the outside of the neck cork and inside of the neck tube, by having a cable routing configuration in accordance with the cable routing configurations 400, 450, 500, 550, 600, 650 from FIGS. 4A, 4B, 5A, 5B, 6A, 6B, potential damaging of the cable from insertion and removal of both the neck cork and the payload can be prevented. Stated another way, by keeping the cable routing configuration away from components that are assembled and disassembled (e.g., the neck cork) and moving components (e.g., the payload), a potential for damage of the cable is prevented, in accordance with various embodiments. In various embodiments, a potential for the cable to fray by the cable being run between the outside of the neck cork and inside of the neck tube is also prevented by the cable routing configurations 400, 450, 500, 550, 600, 650 from FIGS. 4A, 4B, 5A, 5B, 6A, and 6B disclosed herein. In various embodiments, fraying of the cable from typical temperature monitoring systems could result contaminating the payload, which could be costly.

While the preferred embodiments of the disclosure have been shown and described, it will be apparent to those skilled in the art that changes and modifications may be made therein without departing from the spirit of the disclosure, the scope of which is defined by the following claims.

Benefits, other advantages, and solutions to problems have been described herein regarding specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, any of the above-described concepts can be used alone or in combination with any or all the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible considering the above teaching.

What is claimed is:

1. A neck tube assembly for a cryogenic dewar, the neck tube assembly comprising:
a neck tube extending from a first longitudinal end to a second longitudinal end, the neck tube defining a central longitudinal axis, the neck tube comprising an attachment end defining a radial recess between a first radial flange and a second radial flange, the first radial flange disposed at the first longitudinal end, the first radial flange including a first aperture disposed axially through the first radial flange to the radial recess; and
a cable extending through the first aperture into the radial recess.

2. The neck tube assembly of claim 1, wherein the neck tube includes an elongated tubular element extending from the attachment end to the second longitudinal end.

3. The neck tube assembly of claim 2, further comprising a plurality of perforations, each perforation in the plurality of perforations extending radially through the elongated tubular element.

4. The neck tube assembly of claim 1, wherein the cable spirals along a radially outer surface defined by the radial recess from the first radial flange to the second radial flange.

5. The neck tube assembly of claim 1, wherein the second radial flange includes a second aperture extending axially from the radial recess towards the second longitudinal end, wherein the cable extends through the second aperture, and wherein a first sealant is disposed in the first aperture and a second sealant is disposed in the second aperture.

6. The neck tube assembly of claim 1, wherein the cable is bonded to a radially outer surface defined by the radial recess.

7. The neck tube assembly of claim 1, wherein the cable includes a positive wire and a negative wire of a thermocouple disposed therein.

8. The neck tube assembly of claim 1, further comprising a second cable, wherein the cable is a positive wire of a thermocouple, and wherein the second cable is a negative wire of the thermocouple.

9. A dewar, comprising:
an outer vessel;
an inner vessel disposed within the outer vessel;
a neck tube coupled to the outer vessel and extending into a cavity defined by the inner vessel, the neck tube including a first radial flange extending radially outward from a tubular element, the first radial flange including an aperture extending axially therethrough; and
a sensor including a cable and a measurement junction, the cable disposed through the aperture of the neck tube and extending to the measurement junction, the measurement junction coupled to the inner vessel.

10. The dewar of claim 9, wherein the measurement junction is coupled to an outer surface of the inner vessel.

11. The dewar of claim 9, wherein:
the neck tube further comprises a second radial flange spaced apart longitudinally from the first radial flange,
the second radial flange includes a second aperture extending axially therethrough, and
the cable extends through the second aperture into the cavity defined by the inner vessel.

12. The dewar of claim 11, wherein the cable spirals around the tubular element disposed between the first radial flange and the second radial flange.

13. The dewar of claim 9, wherein the measurement junction is disposed within the inner vessel.

14. A dewar, comprising:
an outer vessel;
an inner vessel disposed within the outer vessel;
a neck tube coupled to the outer vessel and extending into a cavity defined by the inner vessel;
a fitting coupled to the outer vessel, the fitting including a first aperture disposed through a first flange of the fitting; and
a sensor including a cable and a measurement junction, the cable disposed through the first aperture, the cable extending to the measurement junction, the measurement junction coupled to the inner vessel.

15. The dewar of claim 14, further comprising a second fitting coupled to the inner vessel, wherein:
the second fitting includes a second aperture disposed through a second flange, and
the cable extends through the second flange of the second fitting to the measurement junction.

16. The dewar of claim 15, wherein the measurement junction is coupled to an internal surface of the inner vessel.

17. The dewar of claim 14, wherein:
the fitting includes a main body coupled to the outer vessel, and
the cable is disposed through the first aperture and around at least one of (1) a tubular element of the neck tube and (2) around the inner vessel.

18. A dewar, comprising:
an outer vessel;
an inner vessel disposed within the outer vessel; and
a device coupled to one of the inner vessel and the outer vessel, the device comprising at least a portion of a temperature sensor and a communications module, the communications module configured to receive temperature readings from the temperature sensor and transmit the temperature readings wirelessly to an external device.

19. The dewar of claim 18, wherein the temperature sensor is configured to estimate a temperature within the inner vessel.

20. The dewar of claim 18, wherein the communications module comprises a transmitter, and wherein the transmitter is configured to transmit the temperature readings via one of a Bluetooth® communication, a near-field communication, or a low energy Bluetooth® communication.
